(19) United States
(12) Patent Application Publication
(10) Pub. No.: US 2017/0321874 A1
(43) Pub. Date: Nov. 9, 2017

(54) Low-Profile Luminaire

(71) Applicant: Christopher Michael Bryant, Social Circle, GA (US)

(72) Inventor: Christopher Michael Bryant, Social Circle, GA (US)

(21) Appl. No.: 14/952,709

(22) Filed: Nov. 25, 2015

Related U.S. Application Data
(60) Provisional application No. 62/084,389, filed on Nov. 25, 2014.

(51) Int. Cl. F21V 29/77; F21V 21/08; F21V 29/83; F21V 23/04; F21V 29/78

(52) U.S. Cl. CPC F21V 29/777; F21V 23/0471; F21V 29/78; F21V 29/83; F21V 21/0832

(57) ABSTRACT

A luminaire can comprise a central opening through which cooling air flows. A lens can extend circumferentially about the central opening. A frame can extend circumferentially about the lens. Cooling air can further flow in a gap between the lens and the frame. Light emitting diodes can emit light towards the lens, and the light can pass through the lens. The frame can provide the luminaire with a disk form, or another appropriate geometry.

### CROSS REFERENCE TO RELATED APPLICATIONS

This application claims priority to U.S. Provisional Patent Application No. 62/084,389 filed Nov. 25, 2014 in the name of Christopher Michael Bryant and entitled “Low-Profile Luminaire,” the entire contents of which are hereby incorporated herein by reference.

### TECHNICAL FIELD

Embodiments of the technology relate generally to a luminaire, and more particularly to a luminaire that dissipates heat through a central opening and an annular opening to maintain an acceptable operating temperature for peripherally located components.

### BACKGROUND

For illumination applications, light emitting diodes (LEDs) offer substantial potential benefit associated with their energy efficiency, light quality, and compact size. However, to realize the full potential benefits offered by light emitting diodes, new technologies are needed. For instance, relative to incandescent lights, light emitting diodes typically utilize different electrical supplies that have different thermal constraints and temperature operating ranges.

Accordingly, there are needs in the art for technologies to utilize light emitting diodes to generate illumination. Need exists for technology to manage heat generated in connection with operating light emitting diodes and for regulating operating temperatures. Need further exists for luminaires that can take advantage of the potential benefits offered by luminaires. A capability addressing one or more such needs, or some other related deficiency in the art, would support improved illumination systems and more widespread utilization of light emitting diodes in lighting applications.

### SUMMARY

A luminaire can comprise a central opening and light emitting diodes that generate heat when operating. The light emitting diodes can be displaced radially relative to the central opening. A light emitting diode driver can be displaced radially relative to the light emitting diodes. Heat sink fins or a chimney effect (or both) can dissipate the heat at the central opening, so that the heat flows radially inward, towards the central opening and away from the driver.

The foregoing discussion of luminaires is for illustrative purposes only. Various aspects of the present technology may be more clearly understood and appreciated from a review of the following text and by reference to the associated drawings and the claims that follow. Other aspects, systems, methods, features, advantages, and objects of the present technology will become apparent to one with skill in the art upon examination of the following drawings and text. It is intended that all such aspects, systems, methods, features, advantages, and objects are to be included within this description and covered by this application and by the appended claims of the application.

### BRIEF DESCRIPTION OF THE FIGURES

Reference will be made below to the accompanying drawings.

FIG. 1 illustrates a perspective view of a bottom side of an example luminaire according to some embodiments of the disclosure.

FIG. 2 illustrates a perspective view of a top side of the example luminaire illustrated in FIG. 1 according to some embodiments of the disclosure.

FIG. 3 illustrates a cross sectional view of the example luminaire of FIGS. 1 and 2 that is overlaid with a simulated heat dissipation diagram according to some embodiments of the disclosure.

FIG. 4 illustrates a cutaway perspective view of the example luminaire illustrated in FIGS. 1, 2, and 3, with an overlay of a simulated airflow diagram according to some embodiments of the disclosure.

FIG. 5 illustrates a perspective view of a bottom side of an example luminaire according to some embodiments of the disclosure.

FIG. 6 illustrates a perspective view of an upper side of the example luminaire illustrated in FIG. 5 according to some embodiments of the disclosure.

FIG. 7 illustrates a side view of the example luminaire illustrated in FIGS. 5 and 6 according to some embodiments of the disclosure.

FIG. 8 illustrates a top view of the example luminaire illustrated in FIGS. 5, 6, and 7 according to some embodiments of the disclosure.

FIG. 9 illustrates a bottom view of the example luminaire illustrated in FIGS. 5, 6, 7, and 8 according to some embodiments of the disclosure.

The drawings illustrate only example embodiments and are therefore not to be considered limiting of the embodiments described, as other equally effective embodiments are within the scope and spirit of this disclosure. The elements and features shown in the drawings are not necessarily drawn to scale, emphasis instead being placed upon clearly illustrating principles of the embodiments. Additionally, certain dimensions or positionings may be exaggerated to help visually convey certain principles. In the drawings, similar reference numerals among different figures designate like or corresponding, but not necessarily identical, elements.

### DETAILED DESCRIPTION OF EXAMPLE EMBODIMENTS

Components of a luminaire can be arranged in radially offset locations relative to a central opening that dissipates heat. The components can include at least one light emitting diode and at least one light emitting diode driver. Heat from the light emitting diode can flow towards the central opening, away from the driver, to provide the driver a suitable operating temperature.

In some example embodiments, a luminaire configuration can reduce total luminaire volume or footprint while mitigating potentially damaging effects of a light source's thermal load on the luminaire's electronics, for example by arranging the luminaire components horizontally or in a radial pattern.

In some example embodiments, a solid-state light source is mounted at or to a heat sink and is encapsulated, covered, or enclosed by an optically active lens. One or more drivers, a motion sensor, and related electronics can be mounted in a concentric housing separated from the light source by the heat sink. A housing cover can enclose an electronics compartment. The resulting luminaire or lighting fixture can be secured to a mounting location via a central hook, a loop, a hanger, one or more lines or wires, or some other appropriate mounting system.

In some example embodiments, the luminaire can provide enhanced thermal management. Light emitting diodes and drivers can have separate heat sinks for enhanced thermal isolation. Concentric rings or other arrangements of light emitting diodes and heat sink fins can receive ample airflow for cooling or thermal regulation. A “chimney effect” generated by a central opening of the luminaire and utilized by the heat sink fins can facilitate thermal transmission to a local atmosphere or ambient environment.

In some example embodiments, the compact luminaire configuration can reduce material usage in the fixture and in packaging. Reduced volume can support efficiency when loading pallets and distributor shelves, for example.

In some example embodiments, an outer ring or peripheral area of the luminaire spans the height of the fixture and provides a compartment for electronic components. The ring can further protect optics of the luminaire against physical damage when packed and during handling. The inherent physical strength of a concentric configuration can further protect the luminaire from over-stacking during shipping.

The outer ring of the luminaire can house a motion sensor, which may be integrated into the housing. A sensor lens can cover the motion sensor. When regressed into the housing, the sensor can be protected during shipping and handling.

In some example embodiments, a low profile configuration of the luminaire can support deployment in a “low bay” fixture application, for example when ceiling and mounting heights are low.

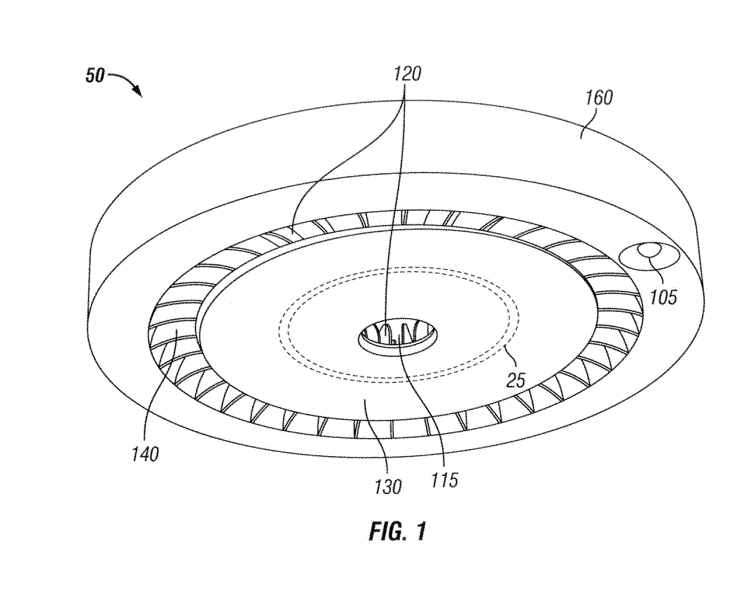

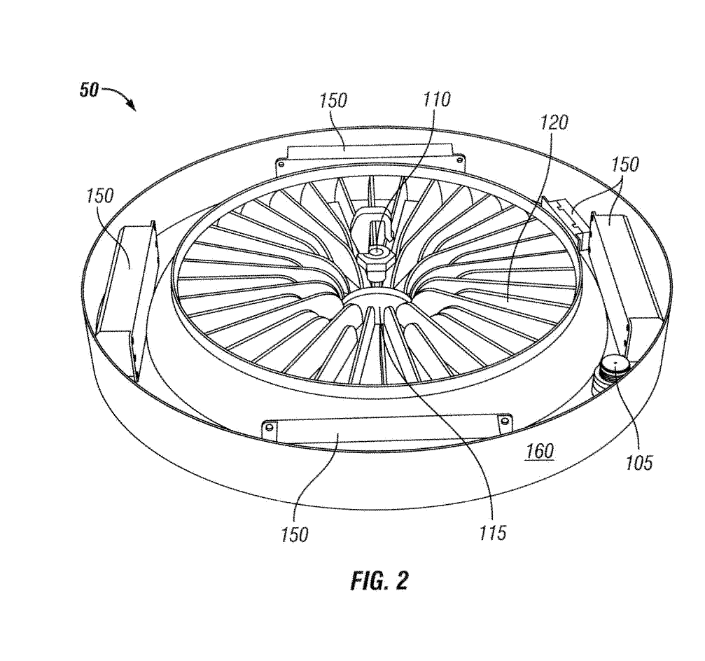

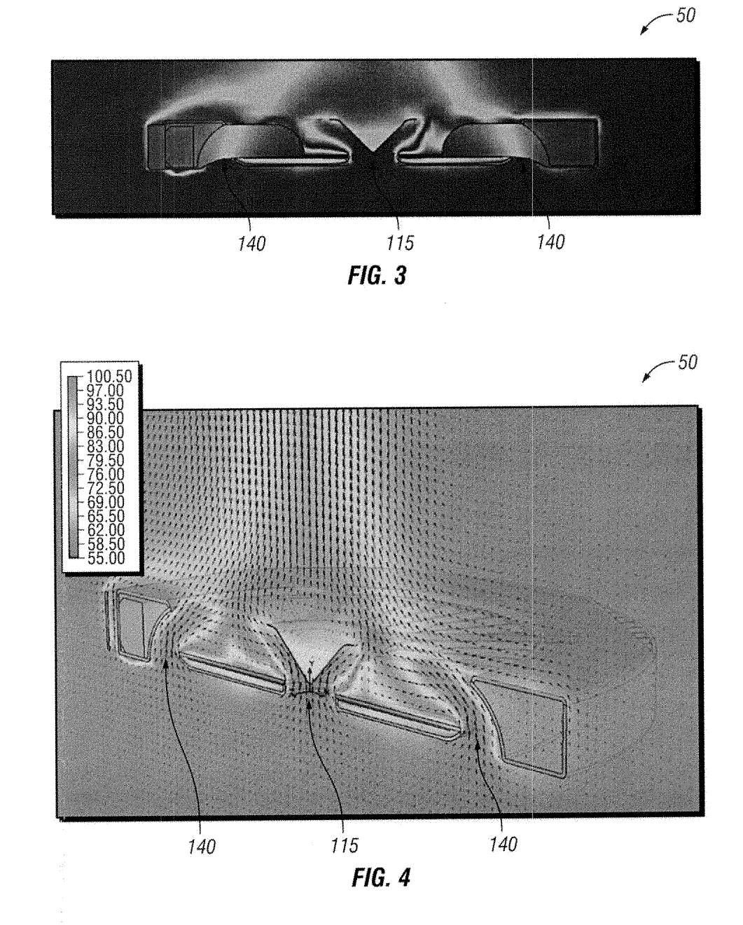

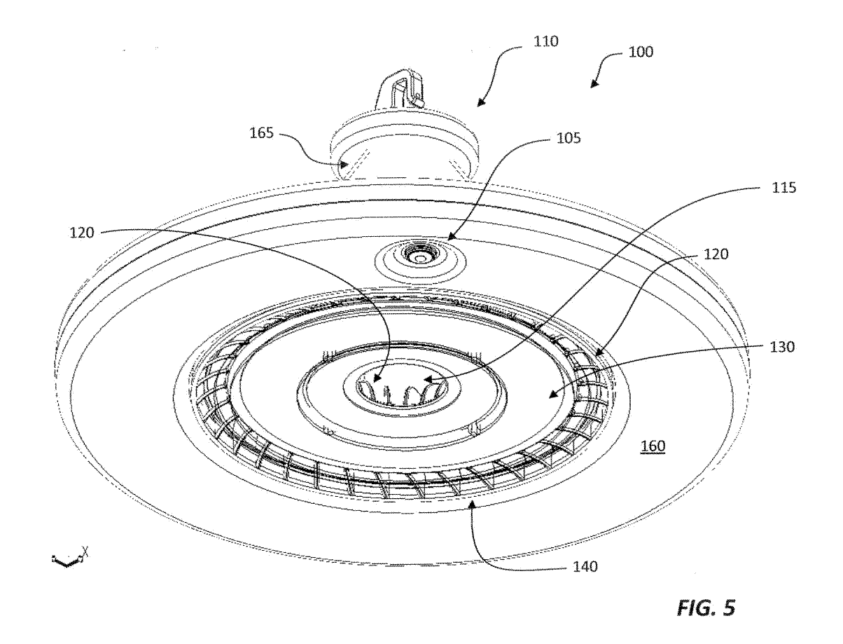

Some representative embodiments will be described more fully hereinafter with example reference to the accompanying drawings that illustrate some representative embodiments of the technology. FIGS. 1 and 2 illustrate two views of an example luminaire 50 according to some embodiments of the present disclosure. FIGS. 3 and 4 illustrate example thermal characteristics of the luminaire 50 according to some embodiments of the present disclosure. FIGS. 5, 6, 7, 8, and 9 illustrate another luminaire 100 according to some embodiments of the present disclosure.

The technology may, however, be embodied in many different forms and should not be construed as limited to the embodiments set forth herein; rather, these embodiments are provided so that this disclosure will be thorough and complete, and will fully convey the scope of the technology to those appropriately skilled in the art.

Referring now to FIGS. 1, 2, 3, and 4, in the illustrated example embodiment, the luminaire 50 has a disk-shaped form and may be mounted overhead. The relatively thin form facilitates installation where overhead room is relatively limited, such as in low bays.

A lens 130 extends peripherally about a central opening 115. Light emitting diodes 25 are mounted under the lens 130, for example in one or more rings about the central opening 115. The light emitting diodes 25 emit light into the backside of the lens 130 (where the backside of the lens faces upward and the light emitting side of the lens faces downward when the luminaire is mounted overhead). The lens 130 manages and may diffuse light emitted by the light emitting diodes 25. In some embodiments, the lens 130 can be formed from plastic loaded with a diffusing agent or with surface features that diffuse light via refraction. Accordingly, the luminaire 50 can emit diffuse light that is well suited for illumination.

In some embodiments, the illustrated lens 130 is replaced with an array of light emitting diodes that have individual lenses. For example, an array light emitting diodes can be mounted to a circuit board (or other substrate) that has a disk shape with a central opening, generally following the geometry of the illustrated lens 130. A corresponding array of lenses can cover the light emitting diodes, so that each light emitting diode has an associated lens. In some example embodiments, those associated lenses are clear and further may include one or more internally reflective structures for spreading light or directing light off axis. The resulting luminaire can provide illumination that is biased in a specified direction in some embodiments. For example, the resulting luminaire can be mounted next to a road, and the luminaire can emit a disproportion amount of illumination towards the road, rather than towards houses or otherwise away from the road.

A frame 160 of the luminaire 50 supports the various luminaire elements. The frame 160 extends circumferentially about the lens 130. The outer edge of the lens 130 is separated from the inner edge of the frame 160 to provide a peripheral gap 140. As illustrated, the peripheral gap 140 extends circumferentially about the lens 130, between the lens 130 and the frame 160. The illustrated peripheral gap 140 can be characterized as an annular opening or as a vent in some embodiments.

A motion sensor 105 (or other occupancy sensor) is located at near the periphery of the frame 160 of the luminaire 50 and is oriented to detect motion in the vicinity of the luminaire 50. Upon detecting motion, the motion sensor 105 can trigger the luminaire 50 to turn on or otherwise emit illumination.

Drivers and associated electronics 150 supply electricity to the light emitting diodes 25 and are also located at the periphery of the luminaire 50. As illustrated, the frame 160 of the luminaire 50 comprises a housing that provides a circumferentially extending enclosure for the drivers and electronics 150. Heat sink fins 120 extend radially outward from the central opening 115. The heat sink fins 120 can alternatively be viewed as extending radially inward towards the central opening 115. In the illustrated embodiment, the luminaire 50 comprises heat sink fins 120 of alternating lengths, with each short fin 120 interleaved between two long fins 120 and each long fin 120 interleaved between two short fins 120.

The luminaire 50 further comprises a mounting hook 110. When the luminaire 50 is suspended from the mounting hook 110 and operated, air moves upward through the central opening 115 via a chimney effect as illustrated in FIG. 4 and discussed below. Air similarly flows upward through the peripheral gap 140.

In the illustrated embodiment, the mounting hook 110 is vertically displaced from the central opening 115 (and from the gap 140) to avoid restricting or interfering with airflow. The resulting airflow removes and dissipates heat from the heat sink fins 120. Accordingly, heat that is generated by the light emitting diodes 25 flows towards the central opening 115 and away from heat sensitive components of the luminaire 50, such as the drivers and associated electronics 150 and the motion detector 105 that are situated towards the periphery of the luminaire 50.

FIGS. 3 and 4 illustrate computer simulations respectively showing heat dissipation and airflow of the luminaire 50. In FIG. 3, a representative cross section of the luminaire 50 is overlaid with a computer-simulated heat dissipation diagram. The diagram shows how heat generated by operating the light emitting diodes 25 flows towards the central opening 115 and thus away from the drivers and associated electronics 150. In FIG. 4, a representative cutaway perspective view of the luminaire 50 is overlaid with a computer-simulated diagram of airflow. The diagram shows how airflow through the central opening 115 and the peripheral gap 140 removes heats from the heat sink fins 120.

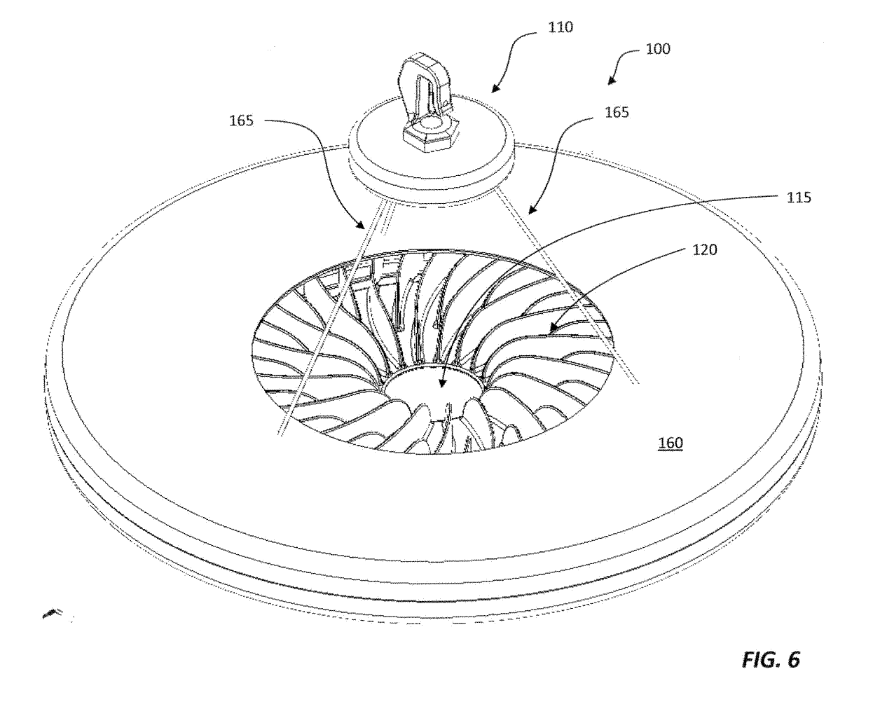

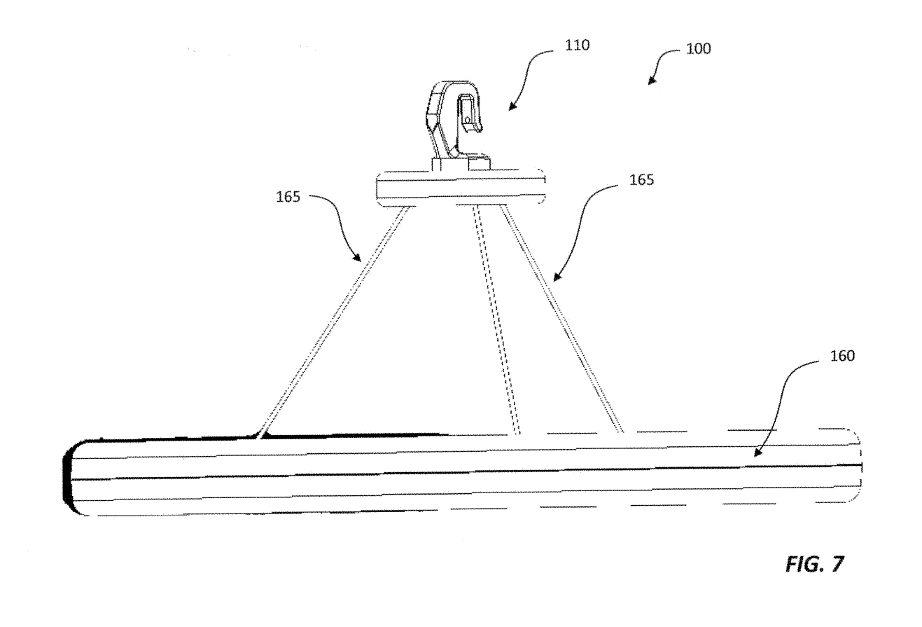

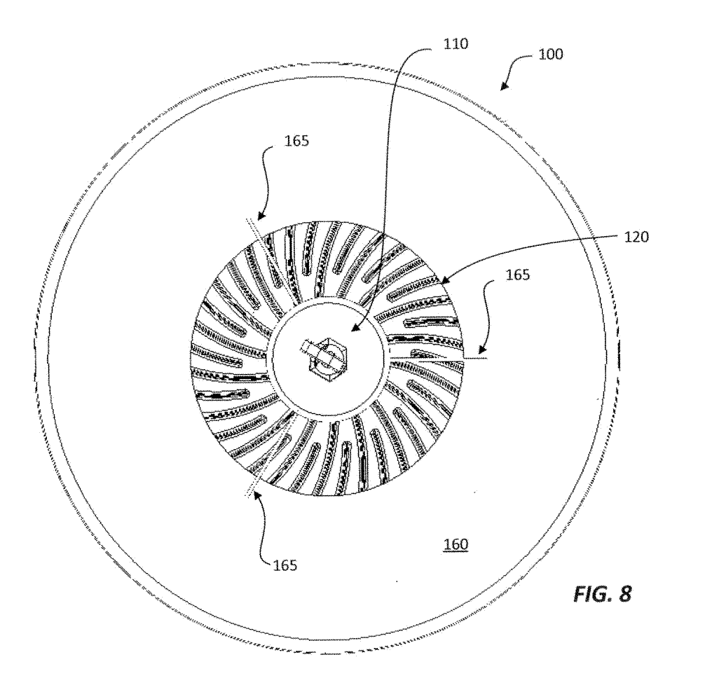

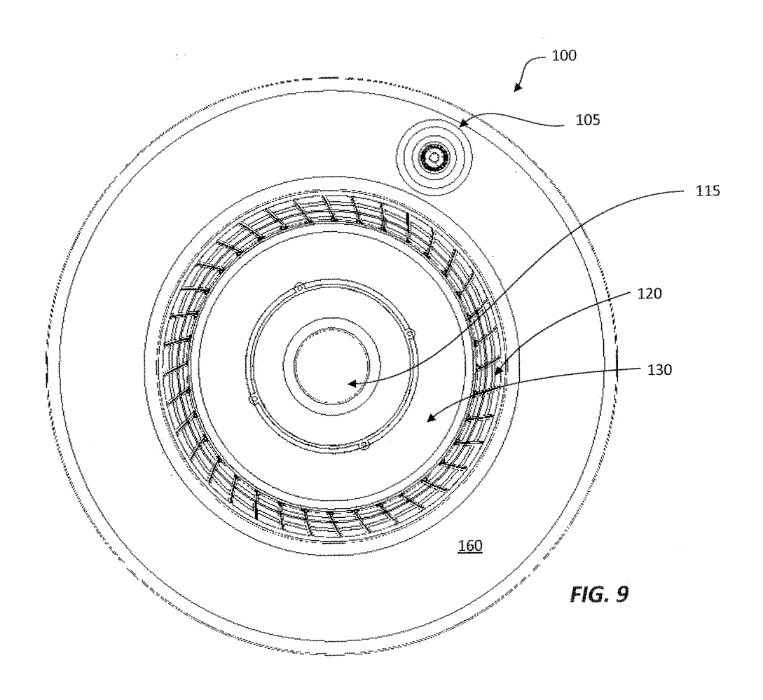

Turning now to FIGS. 5, 6, 7, 8, and 9, these figures illustrate another example luminaire 100 according to some embodiments of the present disclosure. FIG. 5 illustrates a perspective view of the lower side of the luminaire 100. FIG. 6 illustrates a perspective view of the upper side of the luminaire 100. FIG. 7 illustrates a side view of the luminaire 100. FIG. 8 illustrates a top view of the luminaire 100. FIG. 9 illustrates a bottom view of the luminaire 100.

The illustrated luminaire 100 comprises a central opening 115 in the frame 160 that channels air via a chimney effect as discussed above with reference to FIGS. 1, 2, 3, and 4. A lens 130 has a corresponding opening 115 that is aligned to the central opening 115 of the frame 160. Light emitting diodes 25 (see FIG. 1) are located above the lens 130 and emit light downward, through the lens 130, to illuminate an area below the luminaire 100. As discussed above, the lens 130 can comprise a light diffuser in some example embodiments. The lens 130 can comprise various other forms of optics as may be beneficial for various applications.

A motion detector 105 is configured to pick up motion from the illuminated area or a nearby region. Detection of motion triggers light emission from the luminaire 100, as discussed above. In the illustrated embodiment, the motion detector 105 is located along the periphery of the underside of the luminaire 100. Heat generated by the light emitting diodes flows towards the central opening 115 for removal from the luminaire 100, resulting in maintaining the motion detector 105 at an appropriately cool operating temperature.

A driver and associated electronics 150 (not visible in FIGS. 5, 6, 7, 8, and 9 but visible in FIG. 2) is also disposed along the periphery of the luminaire 100, within a circumferentially extending cavity the luminaire frame 160. Channeling heat flow to the central opening 115 keeps the driver and associated electronics 150 relatively cool as illustrated and discussed above with reference to FIGS. 1, 2, 3, and 4.

A hook 110 facilitates mounting to an overhead structure, such as a ceiling. As illustrated, the hook 110 is displaced from the central opening 115 to avoid restricting airflow via a chimney effect and/or convection as discussed above. Lines 165 extend from the hook 110 to the frame 160 of the luminaire 100. The lines 165 can have a composition that includes metal, plastic, or other suitable materials in various embodiments.

The upper side of the luminaire 100 includes exposed heat sink fins 120 that extend radially from the central opening 115. Air flowing upward through the central opening 115 carries heat away from the fins 120, thus drawing heat away from the luminaire's periphery where heat-sensitive components may be located. Thus, heat generated by the light emitting diodes flows generally inward, towards the central opening 115. The illustrated central opening 115 can be characterized as a vent that provides cooling airflow.

The luminaire 100 includes heat sink fins 120 that are exposed on the lower side of the luminaire 100. In the illustrated embodiment of FIG. 9, the heat sink fins 120 are exposed through the peripheral gap 140 that extends circumferentially about the central opening 115. As illustrated in FIGS. 5 and 6, the heat sink fins 120 are visible from above and below the luminaire 100.

As discussed above, embodiments of the peripheral gap 140 can comprise an annular opening or a vent. In some embodiments, the peripheral gap 140 extends from the lower side of the luminaire 100 to the upper side of the luminaire 100. Accordingly, air can flow vertically through the peripheral gap 140 and across the heat sink fin surfaces.

The heat sink fins 120 and configuration of the luminaire 100 manages the heat that is generated by operating the light emitting diodes 25. More specifically, the luminaire 100 can direct heat away from components that are more sensitive to heat than the light emitting diodes 25.

Technology for heat management and a low-profile luminaire that incorporates light emitting diodes has been disclosed. Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A luminaire comprising:
a frame comprising:
an upper side;
a lower side; and
a first opening that extends between the upper side and the lower side;
an optic that is disposed at the lower side of the frame and that comprises a second opening disposed adjacent the first opening; and
a plurality of light emitting diodes that are disposed between the optic and the upper side and that are arranged to emit light onto the optic.

2. The luminaire of claim 1, further comprising a cover that protects a light emitting diode driver disposed along a periphery of the luminaire.

3. The luminaire of claim 1, further comprising heat sink fins that are visible from above the luminaire and from below the luminaire.

4. The luminaire of claim 1, further comprising:
first heat sink fin portions disposed on the upper side of the frame; and
second heat sink fin portions disposed on the lower side of the frame.

5. The luminaire of claim 1, further comprising a driver mounted to the frame in a peripheral location relative to the optic.

6. The luminaire of claim 1, further comprising a motion sensor mounted to the frame in a peripheral location relative to the optic.

7. The luminaire of claim 1, further comprising a mounting hook attached to the upper side of the frame.

8. The luminaire of claim 1, further comprising heat sink fins attached to the frame,
wherein the first opening is configured to cool the heat sink fins by flowing air over the heat sink fins utilizing a chimney effect.

9. A luminaire comprising:
a disk-shaped frame comprising:
a first side;
a second side; and
a centrally disposed opening extending between the first side and the second side;
a lens disposed on the second side;
a light emitting diode disposed between the lens and the first side;
a driver mounted to the frame; and
a plurality of heat sink fins extending radially between the opening and the driver.

10. The luminaire of claim 9, further comprising a cover that covers electronics disposed along a periphery of the luminaire,
wherein the light emitting diode is one light emitting diode in a plurality of light emitting diodes that are arranged in a geometry that extends about the centrally disposed opening, and
wherein the plurality of heat sink fins are operative to dissipate heat generated by operating the plurality of light emitting diodes.

11. The luminaire of claim 9, further comprising an annular opening that extends circumferentially about the centrally disposed opening and that extends between the first side and the second side.

12. The luminaire of claim 11, wherein the centrally disposed opening is configured to flow air over the plurality of heat sink fins based on a chimney effect.

13. The luminaire of claim 12, wherein the annular opening is configured to flow air over the plurality of heat sink fins.

14. A luminaire comprising:
a lens comprising:
a central opening;
an outer edge that extends about the central opening; and
a light-emitting area that extends between the central opening and the outer edge;
a plurality of light emitting diodes oriented to illuminate the light-emitting area of the lens; and
a frame comprising an inner edge that extends about the outer edge of the lens, with a gap between the outer edge of the lens and the inner edge of the frame,
wherein the central opening and the gap are configured to transmit air through the luminaire.

15. The luminaire of claim 14, wherein the luminaire is disk shaped.

16. The luminaire of claim 14, wherein the plurality of light emitting diodes form a ring around the central opening.

17. The luminaire of claim 14, wherein the outer edge of the lens is concentric with respect to the central opening,
wherein the inner edge of the frame is concentric with respect to the lens, and
wherein the gap is concentric with respect to the lens.

18. The luminaire of claim 14, wherein the central opening of the lens, the outer edge of the lens, the light-emitting area of the lens, the inner edge of the frame, and the gap are disposed in a substantially coaxial configuration.

19. The luminaire of claim 14, further comprising heat sink fins disposed adjacent the gap.

20. The luminaire of claim 14, further comprising heat sink fins disposed adjacent the central opening.
